(19) United States
(12) Patent Application Publication
(10) Pub. No.: US 2012/0103455 A1
(43) Pub. Date: May 3, 2012

(54) Quick Drain

(76) Inventor: Raymond Alfred Vanamburg, Redbridge (CA)

(21) Appl. No.: 12/938,778

(22) Filed: Nov. 3, 2010

(51) Int. Cl. F16L 11/00

(52) U.S. Cl. 138/118

(57) ABSTRACT

As a tool to assist in the circulation of water, it is known to have a hose interconnecting two ends namely a water inlet end and water outlet end. In this invention a drain head secured to the water inlet end captures incoming water from the swimming pool. Secured to the water outlet end is a rubber seal firmly connected to the skimmer box inlet opening, assisting to transfer water to the water pump. As when the three aspects of this invention are working in unison, increase the swimming pool water circulation significantly.

### BACKGROUND OF THE INVENTION

The field to which this invention pertains is above ground swimming pools. This invention has the ability to decrease the amount of time it takes to vacuum and winterize above ground swimming pools significantly by overcoming existing, numerous equipment problems that are currently present. For example when vacuuming or winterizing above ground pools in the past it has been noted to be inefficient due to the inability of conventional equipment to decrease air intake and therefore increase the speed of water circulation in the system.

### BRIEF SUMMARY OF THE INVENTION

This invention relates to a manual operable tool to assist in the transfer of water from a swimming pool. It is common in devices for transferring water while draining swimming pools to sustain water flow efficiency only until the time that the water line reaches the low end of the skimmer box. As it is necessary to continue draining the swimming pool as quick and expeditious as possible without interruption, using present equipment of this nature is however inefficient because it withstands only limited amounts of air before eventually succumbing to complete faltering which results in a complete loss of water flow. They are moreover unsatisfactory in that there must be sufficient and consistent water flow for complete pool drainage.

“I have found that these disadvantages may be overcome by providing a drain head secured to the drain hose inlet cuff located on the swimming pool floor at the proper location and a rubber seal secured to the drain hose outlet cuff in a way that when employed onto the skimmer box bottom plate inlet opening it provides for a much tighter connection allowing for a more consistent and quicker transfer of water.

### BRIEF DESCRIPTION OF THE SEVERAL VIEWS OF THE DRAWINGS

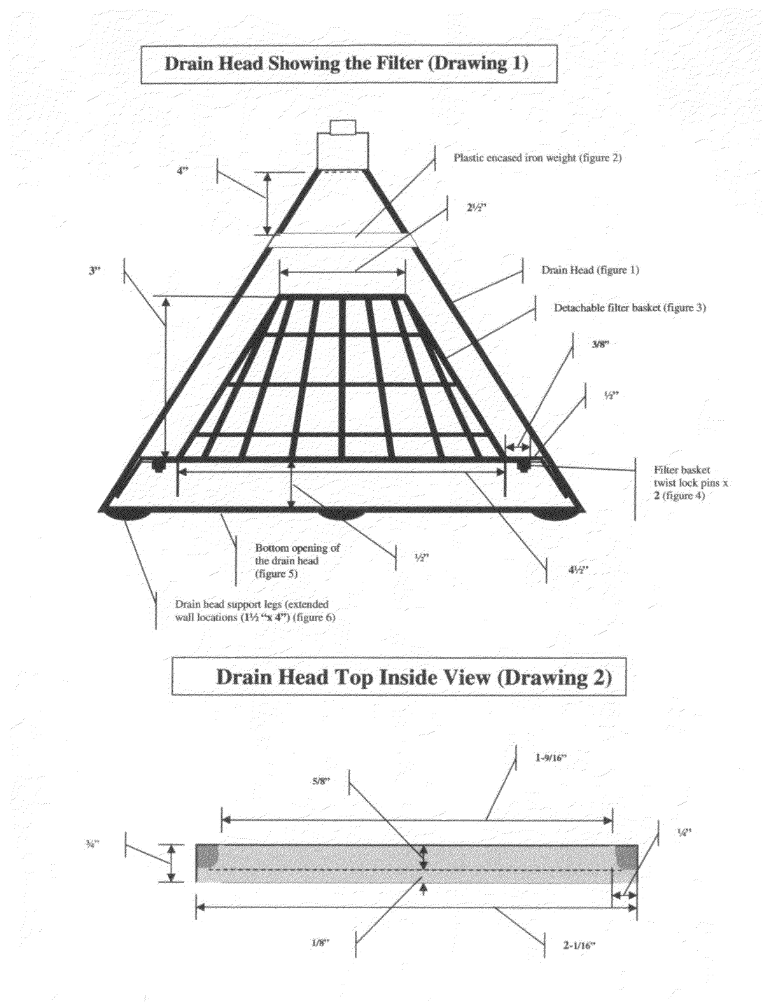

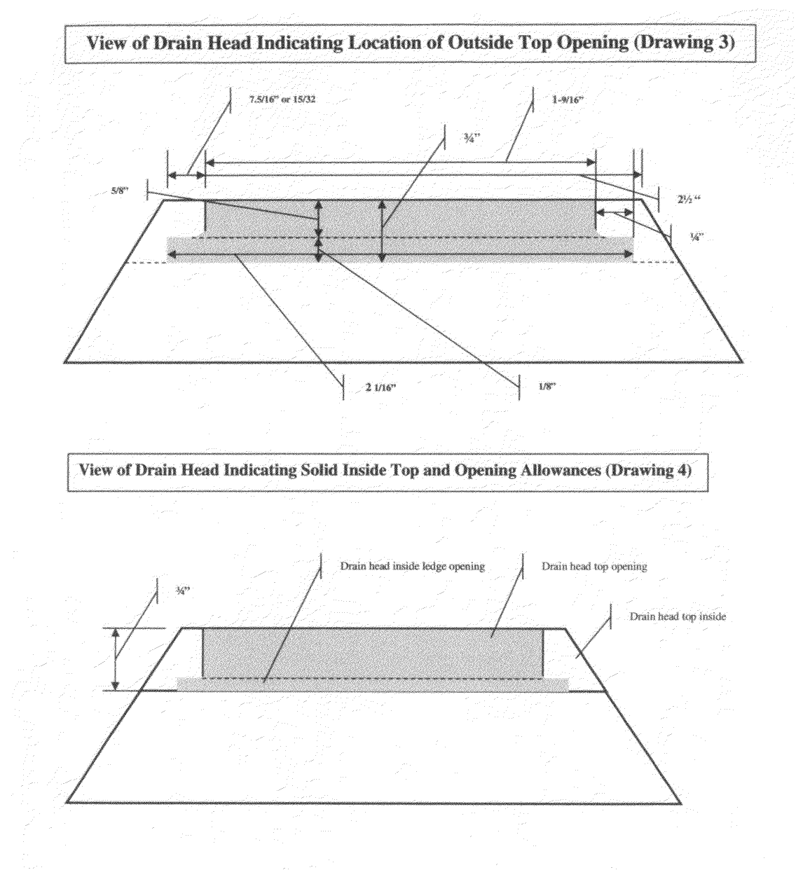

Illustrating the drain head (drawing 1 FIG. 1)

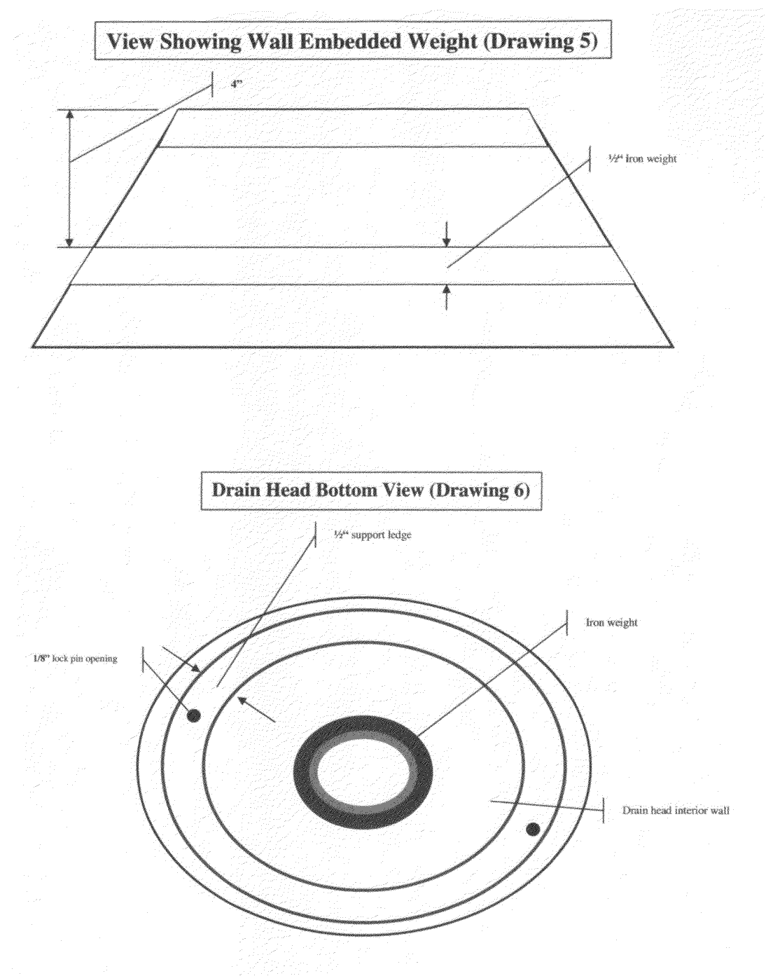

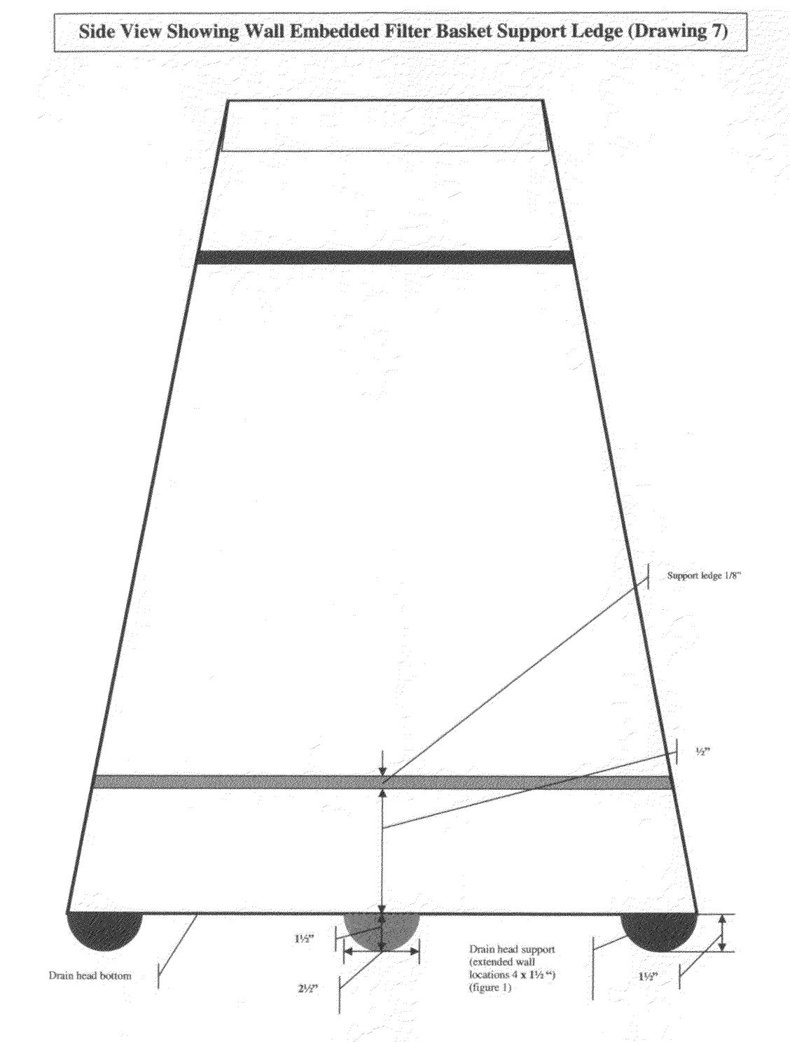

Illustrating location of the plastic incased iron weight (drawing 1 FIG. 2+drawing 5, 6, 11, 12)

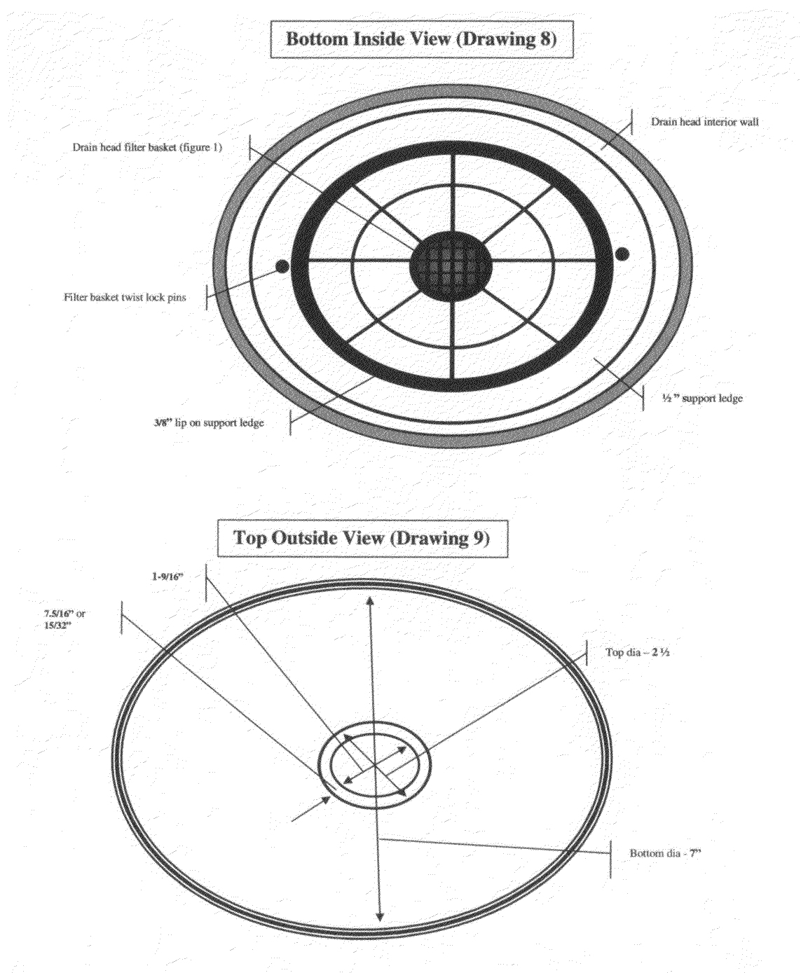

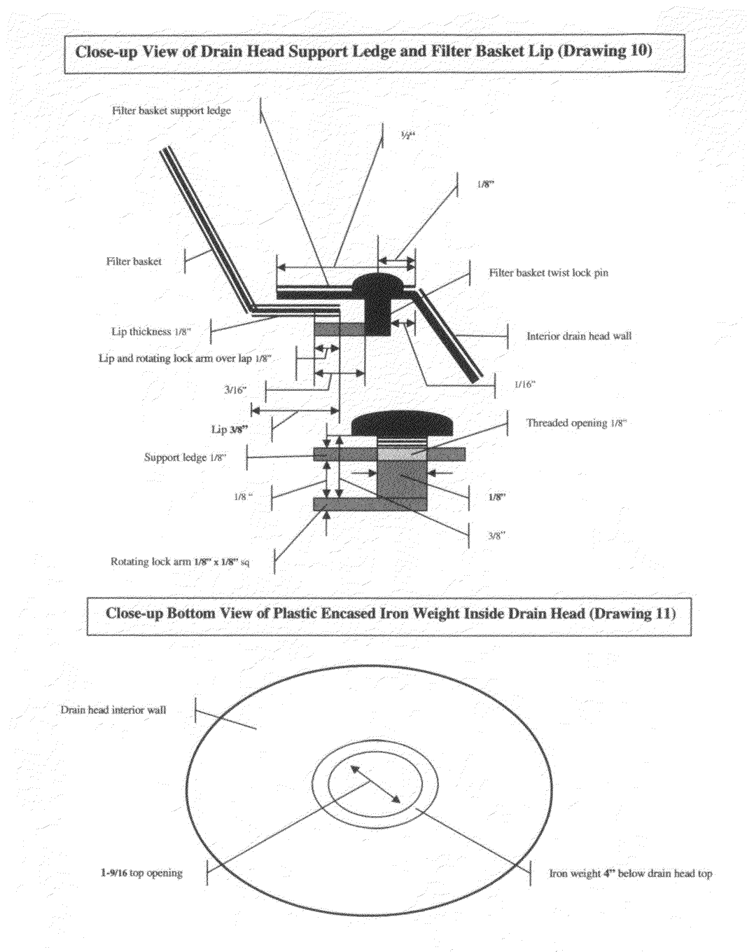

Illustrating location of detachable filter basket (drawing 1 FIG. 3+drawing 8 FIG. 1)

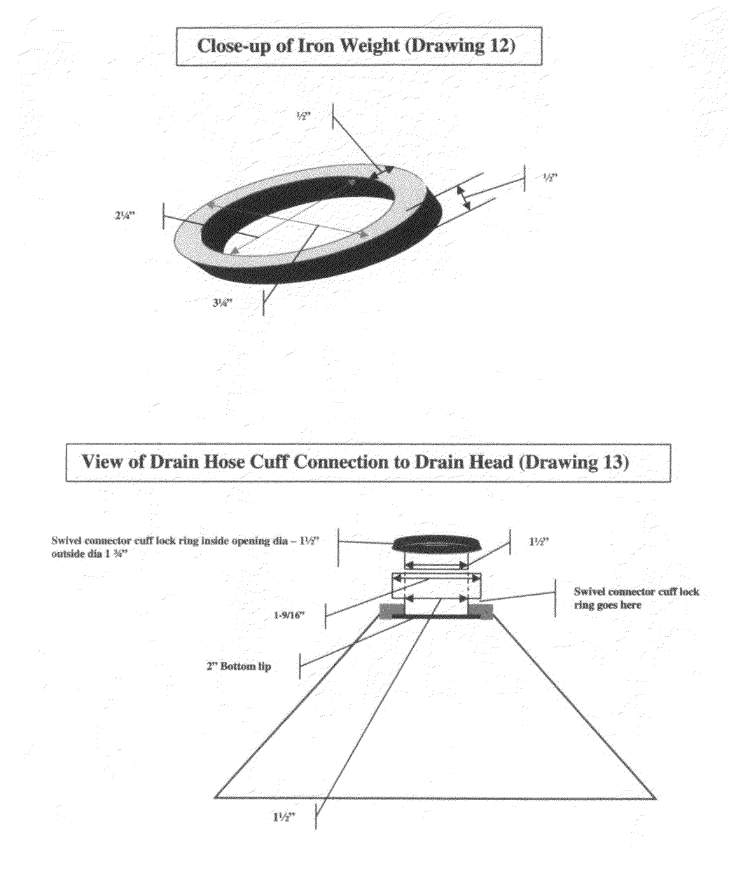

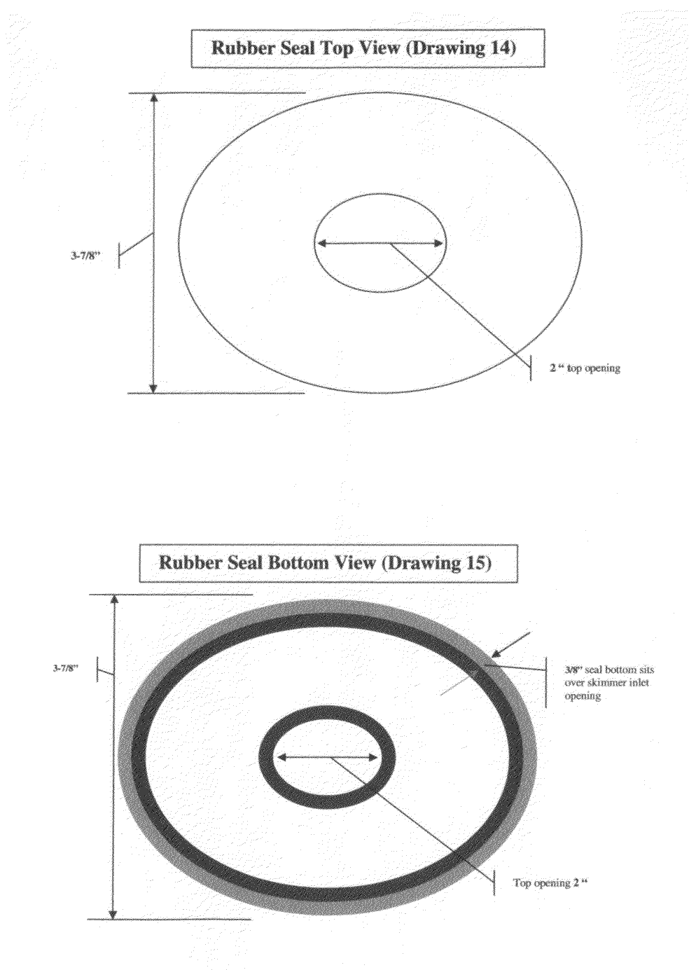

Illustrating location of twist lock pins including close-up view (drawing 1 FIG. 4+drawing 8, 10)

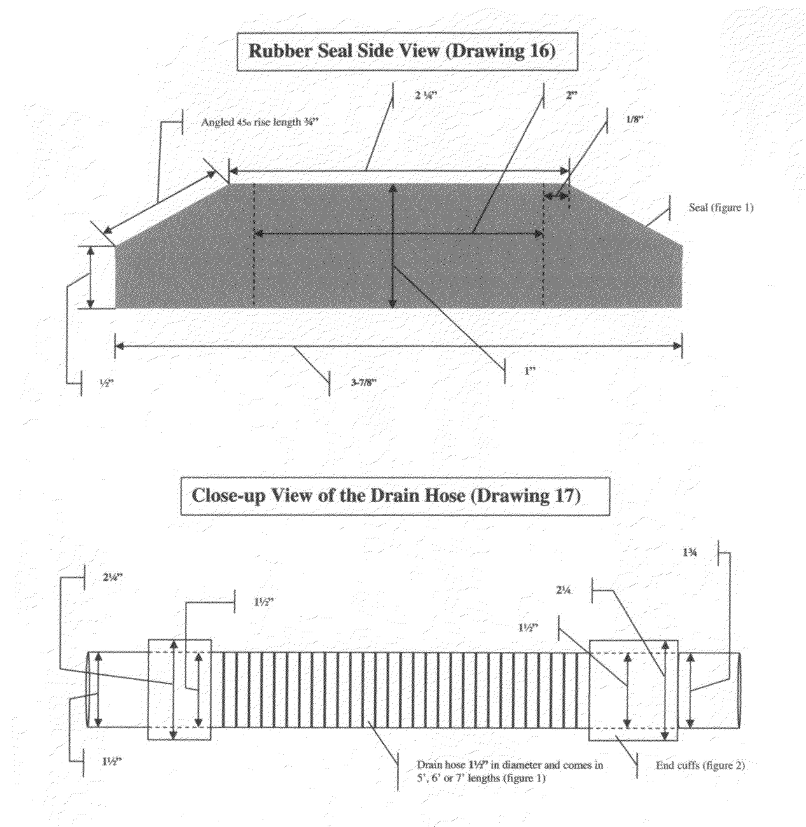

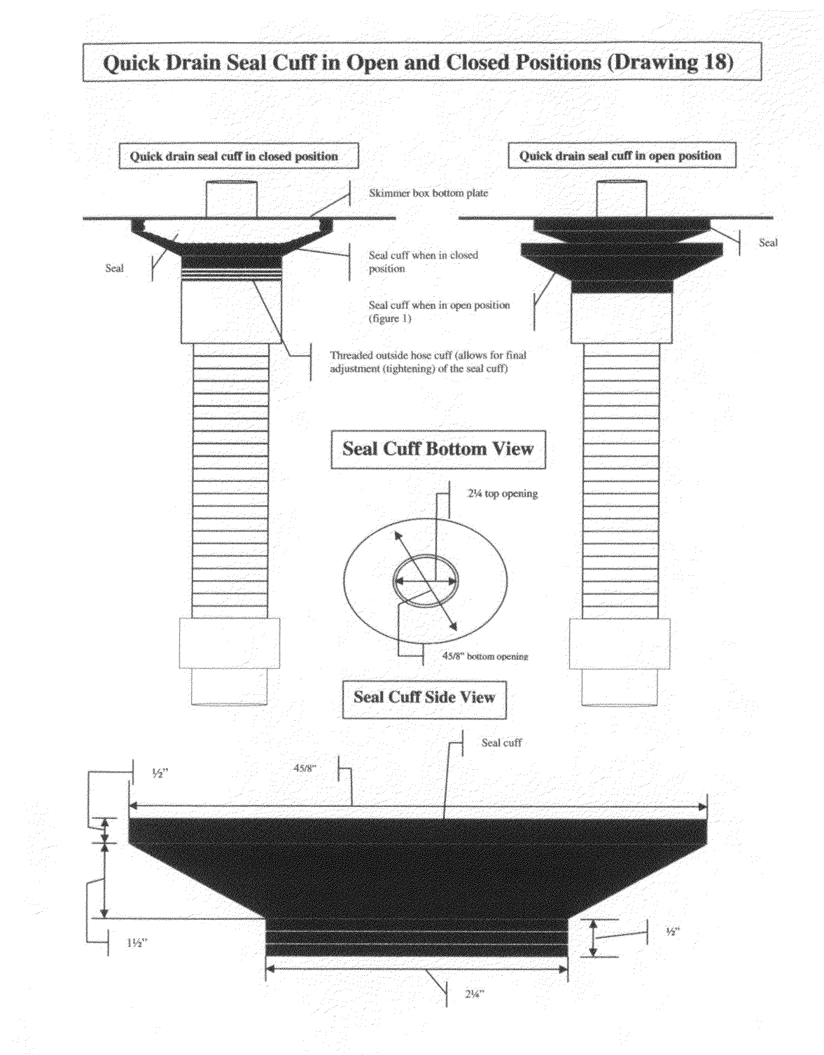

Illustrating the drain head bottom opening (drawing 1 FIG. 5)

Illustrating the drain head hose (drawing 17 FIG. 1)

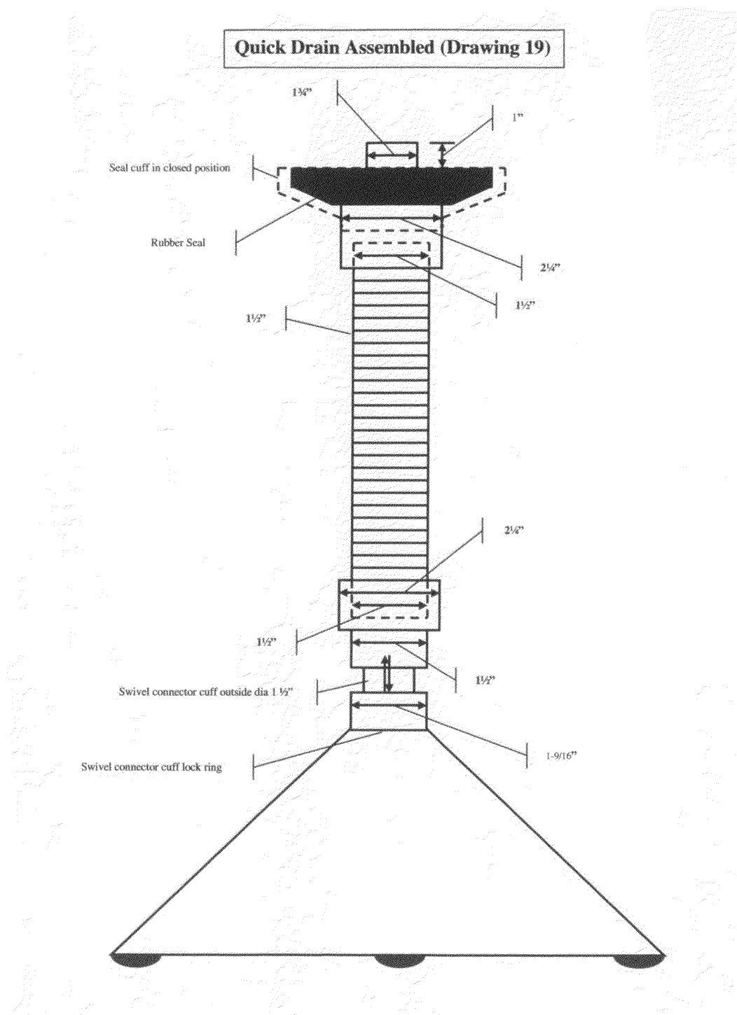

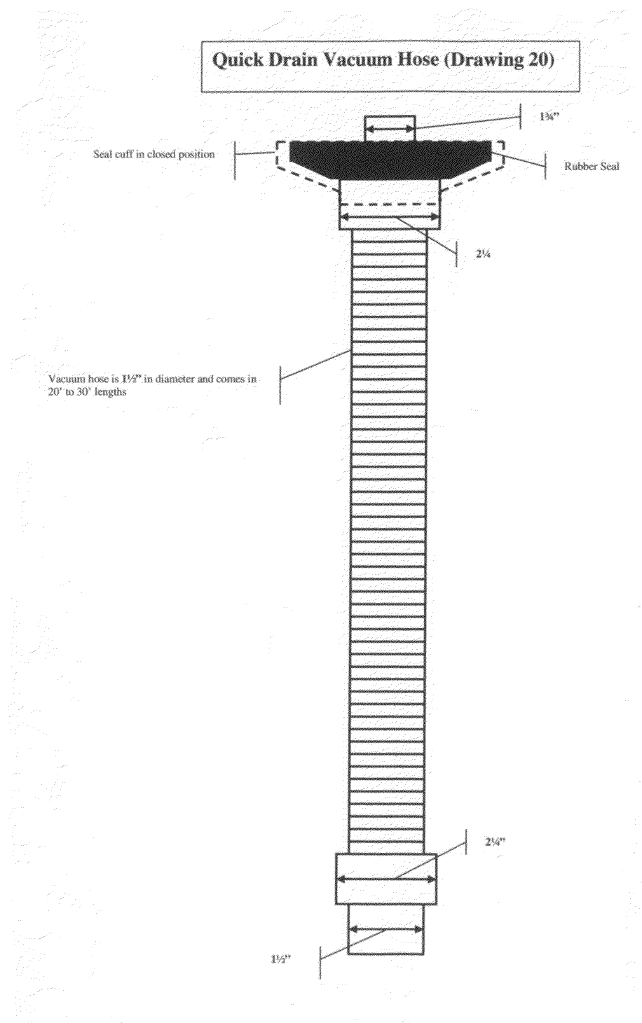

Illustrating the bottom support requirement (extended wall locations) for the drain head (drawing 1 FIG. 6+drawing 7 FIG. 1)

Illustrating the drain hose two end connecting cuffs (drawing 17 FIG. 2)

Illustrating connection location of the seal (drawing 16 FIG. 1+drawing 14, 15, 18, 19, 20)

Illustrating the seal cuff location (drawing 18 FIG. 1+drawing 19, 20)

### CORRESPONDING STATEMENTS

In drawings which illustrate embodiments of the invention which begin with (drawing 1,2,3,4,5,6,7,8,9,11) the drain head illustrated in (drawing 1 FIG. 1) comprises a cone shaped plastic body incasing an iron weight (drawing 1 FIG. 2+drawing 5,6,11,12) to secure the drain head (drawing 1 FIG. 1) so as to allow minimal or no movement while the drain head (drawing 1 FIG. 1) is in its working position. The drain head (drawing 1 FIG. 1) also comprises a detachable filter basket (drawing 1 FIG. 3+drawing 8 FIG. 1) to eliminate any circulating debris from entering the drain hose (drawing 17 FIG. 1).

Bottom support requirement for the drain head (drawing 1 FIG. 1) comprises four half oval shaped extended wall locations (drawing 1 FIG. 6+drawing 7 FIG. 1). The drain hose which transfers the flow of water (drawing 17 FIG. 1) consists of two end connecting cuffs (drawing 17 FIG. 2) by which the drain head (drawing 1 FIG. 1) and the seal (drawing 16 FIG. 1) connect.

Secured to the drain hose outlet cuff (drawing 17 FIG. 2) is the seal (drawing 16 FIG. 1+drawing 14,15,18,19,20) which provides the necessary air tight connection on the skimmer box plate inlet opening, resulting in increased water flow.

The seal cuff (drawing 18 FIG. 1+drawing 19,20) which can be adjusted to lock the seal (drawing 16 FIG. 1) in position with a slight clockwise turn consists of a hollow interior and looking similar in shape but larger to that of the seal (drawing 16 FIG. 1).

### DETAILED DESCRIPTION OF THE INVENTION

Winterizing or vacuuming the swimming pool with the use of older more conventional methods proves inefficient as they are very time consuming and include much un-needed work. The embodiments illustrated with this invention begin with the drain head which comprises a plastic incased iron weight to secure the drain head so as to allow minimal or no movement while the drain head is in its working position. The drain head also comprises a detachable filter basket that connects to the inside. Held in place by two twist lock pins the filter basket collects any debris from attracting water circulating upwards from the drain head bottom that may otherwise enter into the drain hose. Bottom support requirement for the drain head comprises four half oval shaped, extended wall locations providing equal and balanced support. In route to the skimmer box the flow of water passes through the drain hose which consists of two end connecting cuffs by which the drain head and the seal connect. Connected to the skimmer box bottom plate inlet opening providing an air tight connection and making the difference as compared to older equipment of this nature consisting only of a single hose, is the drain hose seal with its rigid firmness providing a smooth and very swift water flow to the water pump.

When vacuuming the system works the same as with winterizing. With the addition of the seals air tight connection providing a much greater vacuum movement you can see the surrounding debris been drawn towards the vacuum head with increased efficiency. Using the vacuum hose and vacuum head are the only equipment changes.

The seal cuff an added attachment to be used essentially when vacuuming the swimming pool attaches to the vacuum hose outlet cuff by threaded adjustment, locking the seal into position in case of hose movement. It consists of a hollow interior, looking similar in shape but larger to that of the seal. This invention has proven to greatly reduce the amount of time it takes to winterize or vacuum above ground swimming pools, as compared to older more conventional methods.

1. In a swimming pool drain hose assembly comprising of a lower attachment, an upper attachment, an interlocking attachment and a pivotal centre attachment interconnecting the upper and lower attachment.

2. An assembled attachment combination mainly comprising the lower attachment being the drain head the upper attachment being the seal and the interlocking attachment being the seal cuff.

3. Wherein the pivotal centre attachment interconnecting the upper attachment and lower attachment defined in claims 1 and 2 as mainly being the drain hose

4. Wherein the completed combination as defined in claims 1, 2, and 3 fit together and in conjunction with each other

5. Wherein the drain head mainly being the lower attachment as defined in claim 2 is located on the swimming pool floor

6. Wherein the connecting drain hose mainly being the centre connecting attachment between the drain head and seal as defined in claim 3, is located running up from the drain head top attachment next to the inside of the swimming pool wall continuing over the swimming pool wall railing and into the inside of the swimming pool skimmer box.

7. Wherein the seal mainly being the upper attachment as defined in claim 2, is attached to the drain hose outlet cuff and is located and firmly connected to the skimmer box bottom plate inlet opening.

8. Wherein the seal cuff mainly being the interlocking attachment as defined in claim 2 is located on the drain hose outlet cuff just above the seal and is adjustably attached so as by turning the seal cuff clockwise will engage the seal into a tighter position.

9. Where-as when all attachments as defined in claims 1, 2, 3, 4, 5, 6, 7 and 8 are assembled together and working in unison with each other provide for quick and constant transfer of water.
